(19) United States
(12) Patent Application Publication
(10) Pub. No.: US 2024/0274316 A1
(43) Pub. Date: Aug. 15, 2024

(54) WIRE HARNESS

(71) Applicant: SUMITOMO WIRING SYSTEMS, LTD., Yokkaichi-shi, Mie-ken (JP)

(72) Inventor: Hiroyuki ARAKAWA, Yokkaichi-shi (JP)

(21) Appl. No.: 18/568,845

(22) PCT Filed: May 26, 2022
(86) PCT No.: PCT/JP2022/021560

§ 371 Date: Dec. 11, 2023

(30) Foreign Application Priority Data
Jun. 14, 2021 (JP) 2021-098466

(51) Int. Cl. H01B 7/00; H02G 3/30

(52) U.S. Cl. CPC H01B 7/0045; H02G 3/30

(57) ABSTRACT

A wire harness that is attachable to an attachment target, including: an electric wire member; a tape member wrapped around an outer circumferential surface of the electric wire member; and a clamp including a belt attached to an outer circumferential surface of the tape member, and an engaging portion that protrudes outward in a radial direction from the belt and is engageable with the attachment target.

### BACKGROUND

### Field of the Disclosure

The present disclosure relates to a wire harness.

This application claims the benefit of priority from Japanese Patent Application No. 2021-098466 filed on Jun. 14, 2021, the description of which is incorporated herein in its entirety.

### Related Art

A wire harness for connecting devices to each other is used in a vehicle or the like. Also, a clamp is conventionally used as a means for fixing the wiring harness to a predetermined attachment target. Japanese Publication No. JP 2018-204752A discloses a clamp (belt clamp) including a belt for holding an electric wire member (a member including an electric wire bundle and a corrugated tube) in a bundled state, and an assembly portion that is assembled to a panel member of the vehicle.

### SUMMARY

A wire harness of the present disclosure is a wire harness that is attachable to an attachment target, including: an electric wire member; a tape member wrapped around an outer circumferential surface of the electric wire member; and a clamp including a belt attached to an outer circumferential surface of the tape member, and an engaging portion that protrudes outward in a radial direction from the belt and is engageable with the attachment target.

### BRIEF DESCRIPTION OF DRAWINGS

FIG. 1 is a side view of a wire harness according to a first embodiment.

FIG. 2 is a cross-sectional view taken along a cutting line II in FIG. 1.

FIG. 3 is a cross-sectional view taken along a cutting line III in FIG. 2.

FIG. 4 is a side view of a wire harness according to a second embodiment.

FIG. 5 is a diagram for describing a method for wrapping a tape member according to the second embodiment.

FIG. 6 is a side view of a wire harness according to a third embodiment.

FIG. 7 is a diagram for describing a method for wrapping a tape member according to the third embodiment.

FIG. 8 is a cross-sectional view taken along a cutting line VIII in FIG. 7.

### DETAILED DESCRIPTION

As a procedure for fixing a wire harness to an attachment target, a worker first manually attaches a clamp to an electric wire member to form a clamp-equipped electric wire member (that is, a wire harness), and then attaches the clamp to an attachment target. Here, when attaching the clamp to the attachment target, the worker may strongly pull the clamp toward the attachment target with his/her hand. At this time, if the clamp deviates (laterally shifts) in the longitudinal direction of the electric wire member, the wire harness cannot be accurately attached to the attachment target. Thus, lateral shifting of the clamp needs to be suppressed.

Japanese Publication No. JP 2018-204752A discloses a technology where, after the clamp has been attached to the electric wire member, lateral shifting is suppressed by laser welding the belt to the electric wire member. However, a piece of equipment such as a laser apparatus is required to perform laser welding, which is costly, and a worker needs to be educated on how to use the laser apparatus and undergo safety training, for example.

In view of these issues, it is an object of the present disclosure to more easily suppress lateral shifting of a clamp in a wire harness.

With the present disclosure, lateral shifting of the clamp can be more easily suppressed.

### Description of Embodiments of Present Disclosure

The scope of the embodiments of the present disclosure includes the following configurations.

(1) A wire harness of the present disclosure is a wire harness that is attachable to an attachment target, including: an electric wire member; a tape member wrapped around an outer circumferential surface of the electric wire member; and a clamp including a belt attached to an outer circumferential surface of the tape member, and an engaging portion that protrudes outward in a radial direction from the belt and is engageable with the attachment target.

The tape member is interposed between the belt and the exterior member, and thus the belt can be caused to bite into the outer circumferential surface of the tape member. Accordingly, it is easier to suppress lateral shifting of the clamp.

(2) It is preferable that the tape member includes a portion where the tape member is wrapped a plurality of times such that overlapping occurs over a predetermined length of the tape member that is shorter than a width of the tape member in a width direction, and the length from one end in the width direction of the wrapped tape member to another end in the width direction is greater than or equal to two times the width of the tape member.

By employing such a configuration, as a result of increasing the length of the wrapped tape member in the longitudinal direction, and increasing the area of contact between the tape member and the electric wire member, it is possible to suppress sliding of the clamp together with the tape member in the longitudinal direction along the outer circumferential surface of the electric wire member. Accordingly, lateral shifting of the clamp can be more reliably suppressed.

(3) It is preferable that the predetermined length is half the width of the tape member.

By employing this configuration, at least two portions of the tape member are overlapped in the radial direction. Accordingly, it is possible to increase the thickness of the wrapped tape member in the radial direction while increasing the length of the wrapped tape member in the longitudinal direction. Consequently, the belt is more likely to bite into the tape member, and it is possible to suppress sliding of the clamp together with the tape member in the longitudinal direction along the outer circumferential surface of the electric wire member.

(4) It is preferable that a gap is formed between a portion of the outer circumferential surface of the electric wire member and a portion of the tape member.

In such a configuration, the adhesive force between the tape member and the electric wire member may be overpowered by the force with which the clamp is pulled on, and the clamp may slide together with the tape member in the longitudinal direction along the outer circumferential surface of the electric wire member. However, the tape member is wrapped so that the length thereof is increased in the longitudinal direction, and thus it is possible to suppress sliding of the clamp together with the tape member in the longitudinal direction along the outer circumferential surface of the electric wire member.

(5) It is preferable that the electric wire member has an electric wire and an exterior member covering the electric wire, the exterior member has annular protrusions and annular recesses alternately provided along a longitudinal direction, the tape member is wrapped around an outer circumferential surface of the exterior member, and the gap is formed between the tape member and the annular recesses.

(6) It is preferable that the electric wire member includes a plurality of electric wires adjacent in the radial direction, and the gap is formed in a portion where the tape member extends between the plurality of electric wires.

(7) It is preferable that the tape member includes a first tape member and a second tape member thicker than the first tape member, and the belt is attached to an outer circumferential surface of the second tape member.

(8) It is preferable that the first tape member is wrapped around a portion of the outer circumferential surface of the second tape member that includes an end portion of the second tape member.

The second tape member is thicker than the first tape member, and thus an end portion thereof can more easily separate from the electric wire member. Thus, by wrapping the thinner first tape member around a portion of the outer circumferential surface of the second tape member that includes the end portion of the second tape member, it is possible to suppress separation of the second tape member from the electric wire member.

(9) It is preferable that the electric wire member has a first region where an electric wire is covered by an exterior member and a second region where the electric wire is not covered by the exterior member, and the belt is attached to a portion of the outer circumferential surface of the second tape member that is wrapped around the second region.

By employing this configuration, the portion of the electric wire not covered by the exterior member can be protected by the thicker second tape member.

(10) It is preferable that the first tape member is wrapped so as to extend across the first region and the second region.

The portion extending across the first region and the second region is particularly unlikely to separate from the second tape member. By wrapping the first tape member around such a portion, it is possible to more reliably suppress separation of the second tape member from the electric wire member.

### DESCRIPTION OF EMBODIMENTS OF PRESENT DISCLOSURE

Hereinafter, details of embodiments of the present disclosure will be described with reference to the drawings.

### First Embodiment

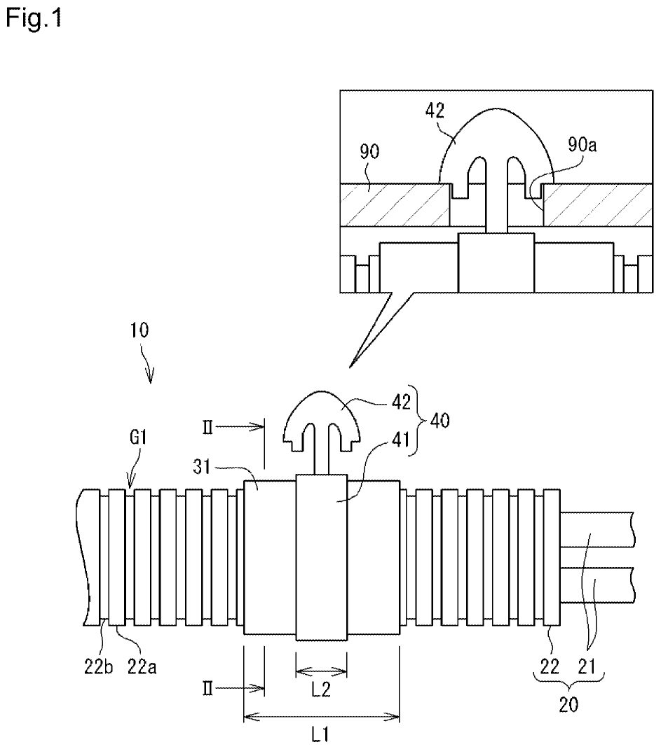

FIG. 1 is a side view of a wire harness 10 according to a first embodiment.

The wire harness 10 is a member that can be attached to an attachment target 90. The attachment target 90 is a panel member provided inside a vehicle, for example. Note that the attachment target 90 is not particularly limited and may be a casing for a device, for example. The wire harness 10 includes an electric wire member 20, a tape member 31, and a clamp 40.

The electric wire member 20 has electric wires 21 and an exterior member 22 that covers the electric wires 21. The electric wires 21 are electric wires that each include a resin coating. The electric wire member 20 of the present embodiment includes two electric wires 21, but the number of electric wires 21 included in the wire member 20 is not particularly limited, and may be one or three or more.

The exterior member 22 is a corrugated tube made of a resin such as polypropylene, or the like. The exterior member 22 has annular protrusions 22a and annular recesses 22b that are alternately provided along the longitudinal direction. That is, the exterior member 22 has a bellows structure.

The outer diameter of each annular protrusion 22a falls within the range of 15 mm or more to 20 mm or less, for example. The outer diameter of each annular recess 22b falls within the range of 12 mm or more to 17 mm or less, for example, and a gap G1 of approximately 3 mm is formed between the outer circumferential surface of the annular recess 22b and the outer circumferential surface of the annular protrusion 22a. The longitudinal width of the annular protrusion 22a is, for example, 1.9 mm, and the longitudinal width of the annular recess 22b is, for example, 1.6 mm. Note that the dimensions of the above exterior member 22 are examples, and an exterior member 22 with different dimensions may be used.

The tape member 31 is a piece of adhesive tape in which an adhesive is provided on one surface of a base material made of a resin such as polyvinyl chloride (PVC), for example. A softer resin (with lower rigidity) than the resin forming the exterior member 22 is used as a base material of the tape member 31, for example. The thickness of the tape member 31 is 0.2 mm, for example. The tape member 31 is wrapped around the outer circumferential surface of the electric wire member 20 with the adhesive surface facing inward.

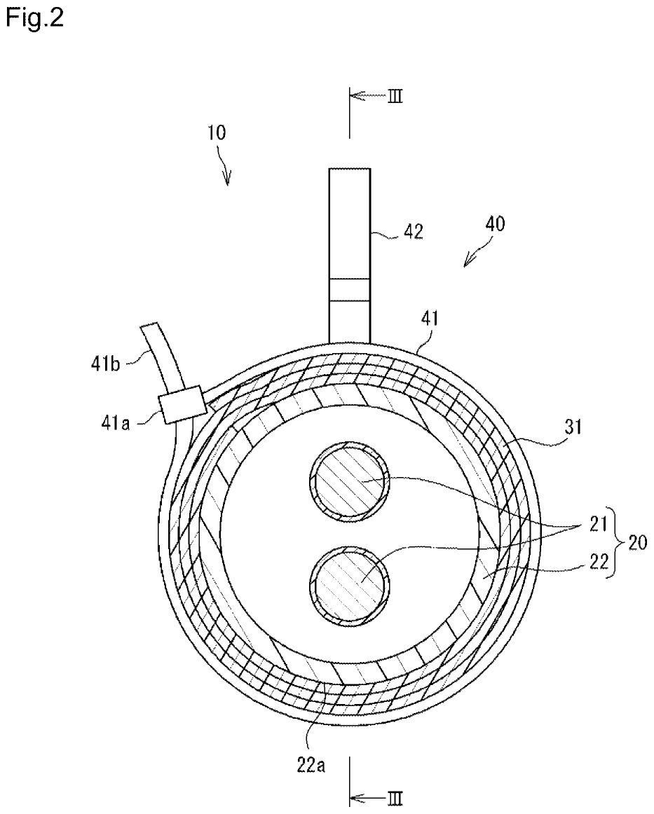

FIG. 2 is a cross-sectional view taken along a cutting line II in FIG. 1.

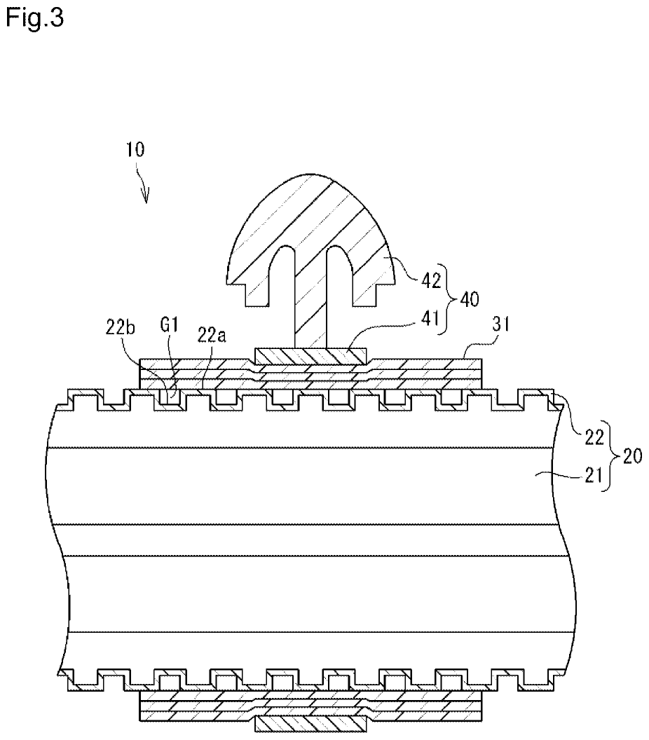

FIG. 3 is a cross-sectional view taken along a cutting line III in FIG. 2.

More specifically, the tape member 31 is wrapped, using “pitch-wrapping”, a plurality of times (three wraps, for example) around the outer circumferential surface of the exterior member 22, as shown in FIG. 2. The term “pitch-wrapping” refers to how the tape member 31 is wrapped for the second and following wraps at the same place as where the first wrap of the tape member 31 was formed, as shown in FIG. 3. Thus, a length L1 from one end in the width direction of the wrapped tape member 31 to the other end in the width direction is equal to the width of the tape member 31. Also, the thickness of the wrapped tape member 31 from the inner side (inner circumferential surface of the first wrap) to the outer side (outer circumferential surface of the third wrap) is approximately 0.6 mm.

The wrapped tape member 31 is in contact with outer circumferential surfaces of the annular protrusions 22a, but is not in contact with outer circumferential surfaces of the annular recesses 22b, and the above gap G1 is formed between the tape member 31 and the outer circumferential surfaces of the corresponding annular recess 22b. The length L1 (=width of the tape member 31) of the present embodiment is, for example, 19 mm, and the tape member 31 is in contact with the outer circumferential surfaces of at least four annular protrusions 22a.

The clamp 40 is a resin member, for example, and has a belt 41 and an engaging portion 42. The belt 41 is a portion that is attached to the outer circumferential surface of the tape member 31. A width L2 of the belt 41 is, for example, 3 mm, and is smaller than the length L1 of the tape member 31 and larger than the width of an annular recess 22b. The belt 41 has a lock member 41a at one end portion thereof, for example, and the belt 41 is attached to the outer circumferential surface of the tape member 31 by being wrapping around the outer circumferential surface of the tape member 31 and then inserting another end portion 41b into the lock member 41a.

The engaging portion 42 is a portion that protrudes outward in a radial direction from the belt 41 and can be engaged with the attachment target 90. The engaging portion 42 is engaged with the attachment target 90 as a result of being inserted into a hole 90a provided in the attachment target 90, as shown in the balloon in FIG. 1, for example. Note that the engaging portion 42 may be engaged with the attachment target 90 using another method. For example, the engaging portion 42 may be attached to a locking piece provided on the attachment target 90. The shape of the engaging portion 42 shown in FIG. 1 is illustrative and may have another shape.

Next, operation and effects of the present embodiment will be described.

For example, if the belt 41 is directly attached to the outer circumferential surface of the exterior member 22 without the tape member 31 being interposed therebetween, when the engaging portion 42 is attached to the attachment target 90, it is highly likely that the belt 41 will slide in the longitudinal direction along the circumferential surface of the exterior member 22, and the clamp 40 will shift (laterally shift) in the longitudinal direction of the electric wire member 20. If the belt 41 is more tightly fastened to the exterior member 22 in an attempt to prevent this, the exterior member 22 may be crushed in the radial direction and the strength of the exterior member 22 may decrease.

In the present embodiment, the tape member 31 is interposed between the belt 41 and the exterior member 22. Here, the tape member 31 is softer than the exterior member 22 and is pitch-wrapped a plurality of times around the outer circumferential surface of the exterior member 22, and thus has a certain thickness. Thus, as shown in FIG. 3, when the belt 41 is fastened to the outer circumferential surface of the tape member 31 at a strength with which the exterior member 22 is not crushed, the outer circumferential surface of the tape member 31 recedes inward in the radial direction, and the belt 41 bites into the tape member 31.

Thus, as a result of the portion of the tape member 31 not fastened by the belt 41 being located outward of the inner circumferential surface of the belt 41 in the radial direction, and side surfaces of the belt 41 interfering with the tape member 31, movement of the belt 41 in the longitudinal direction is restricted. Consequently, lateral shifting of the clamp 40 is suppressed.

In the present embodiment, no large mechanical device such as a laser apparatus is required as with the conventional technique, and it is sufficient that the tape member 31 is interposed between the belt 41 and the exterior member 22, and thus lateral shifting of the clamp 40 can be more easily suppressed.

### Second Embodiment

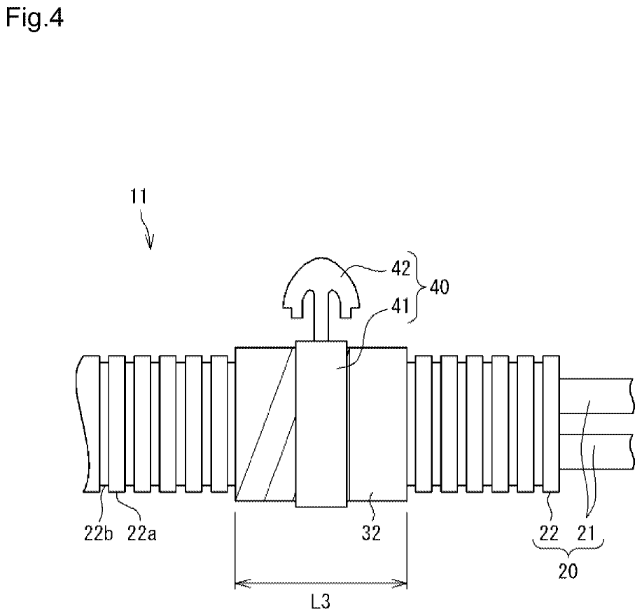

FIG. 4 is a side view of a wire harness 11 according to a second embodiment. In the second embodiment, configurations common with the first embodiment are given the same reference symbols, and description thereof is omitted as necessary.

The wire harness 11 includes an electric wire member 20, a tape member 32, and a clamp 40. The wire harness 10 of the first embodiment differs from the wire harness 11 of the present embodiment in how the tape member 32 is wrapped, and other aspects are equivalent.

In the wire harness 10 of the first embodiment, as a result of interposing the tape member 31 between the belt 41 and the exterior member 22 and causing the belt 41 to bite into the outer circumferential surface of the tape member 31, lateral shifting of the clamp 40 is suppressed.

However, if the clamp 40 is pulled on more strongly, the clamp 40 may slide together with the tape member 31 along the outer circumferential surface of the exterior member 22 in the longitudinal direction. In particular, a gap G1 is formed between a portion of the tape member 31 and the exterior member 22, and thus the adhesive force between the tape member 31 and the exterior member 22 may be overpowered by the force with which the clamp 40 is pulled on.

Thus, in the second embodiment, in order to suppress longitudinal sliding of the tape member 31 itself along the circumferential surface of the exterior member 22, the method for wrapping the tape member 31 is changed from “pitch-wrapping” of the first embodiment to “lap-wrapping”. To discern the tape member of the second embodiment from the tape member 31 that is pitch-wrapped, the tape member is referred to as a “tape member 32”. The material and dimensions of the tape member 32 of the present embodiment are equivalent to those of the tape member 31. Note that the materials and the dimensions of the tape member 32 may differ from those of the tape member 31.

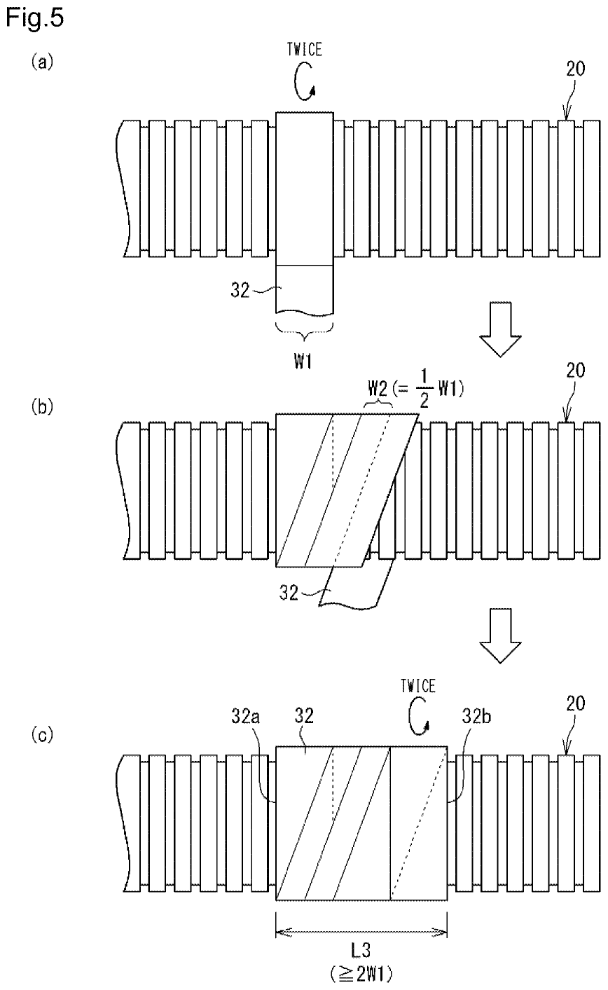

FIG. 5 is a diagram for describing a method for wrapping the tape member 32. The tape member 32 includes a portion that is wrapped, using lap-wrapping, around the outer circumferential surface of the exterior member 22, as described above. The term “lap-wrapping” refers to how the tape member 32 is wrapped such that overlapping occurs over a predetermined length W2 that is shorter than the width W1 of the tape member 32 in the width direction.

As shown in (a) in FIG. 5, first, the tape member 32 is pitch-wrapped for only two wraps around the outer circumferential surface of the exterior member 22. That is, the tape member 32 is wrapped perpendicularly two times such that the width W1 thereof is completely overlapped. Next, as shown in (b) in FIG. 5, the tape member 32 is wrapped obliquely three times such that the wraps overlap each other by the predetermined length W2. The predetermined length W2 of the present embodiment is half of the width W1 of the tape member 32 (W2=½×W1). In this way, the wrapping method in which a tape member is wrapped so that half thereof in the width direction is overlapped will be referred to as “half lap-wrapping”.

Lastly, as shown in (c) in FIG. 5, the tape member 32 is pitch-wrapped only two times around the outer circumferential surface of the exterior member 22. A length L3 from one end 32a in the width direction of the wrapped tape member 32 to the other end 32b in the width direction is, for example, 40 mm, and may be greater than or equal to two times the width W1 (=19 mm) of the tape member 32.

After the tape member 32 has been wrapped around the outer circumferential surface of the exterior member 22, the belt 41 is attached to the outer circumferential surface of the tape member 32, as shown in FIG. 4. By fastening the belt 41 to the outer circumferential surface of the tape member 32, the belt 41 bites into the outer circumferential surface of the tape member 32, and thus it is possible to suppress movement of the belt 41 in the longitudinal direction relative to the outer circumferential surface of the tape member 32.

Also, as a result of pitch-wrapping the two end portions of the tape member 32 in the longitudinal direction, the tape member 32 is prevented from separating from the exterior member 22, and lap-wrapping the central portion of the tape member 32 in the longitudinal direction increases the length L3. The length L3 is further increased in the longitudinal direction, and thus the area of contact between the tape member 32 and the exterior member 22 is increased, and the tape member 32 is less likely to separate from the exterior member 22. Accordingly, it is possible to suppress sliding of the clamp 40 together with the tape member 32 in the longitudinal direction along the outer circumferential surface of the exterior member 22, and lateral shifting of the clamp 40 can be more reliably suppressed.

In particular, in the present embodiment, the tape member 32 is wrapped such that half of the width W1 thereof is overlapped, and thus at least two portions of the tape member 32 are overlapped in the radial direction. Accordingly, the thickness of the wrapped tape member 32 in the radial direction can be increased, and the length L3 in the longitudinal direction can be increased, and thus the belt 41 can more easily bite into the tape member 32, and it is possible to suppress sliding of the clamp 40 together with the tape member 32 in the longitudinal direction along the outer circumferential surface of the exterior member 22.

Note that the predetermined length W2 may be larger than half of the width W1, for example. Also, in the present embodiment, the tape member 32 is first pitch-wrapped two times, then lap-wrapped three times, and lastly pitch-wrapped two times, but the tape member 32 may be wrapped using only lap-wrapping and not using pitch-wrapping at the beginning and the end of the wrapping. Also, in each wrapping method, the number of times the tape member is wrapped is not limited, and the tape member may be wrapped more times than in the present embodiment. For example, the tape member 32 may be pitch-wrapped three times or lap-wrapped four times.

Also, the above countermeasure is realized by wrapping the tape member 32, and thus lateral shifting of the clamp 40 can be suppressed more easily than in conventional technology employing a laser apparatus.

### Third Embodiment

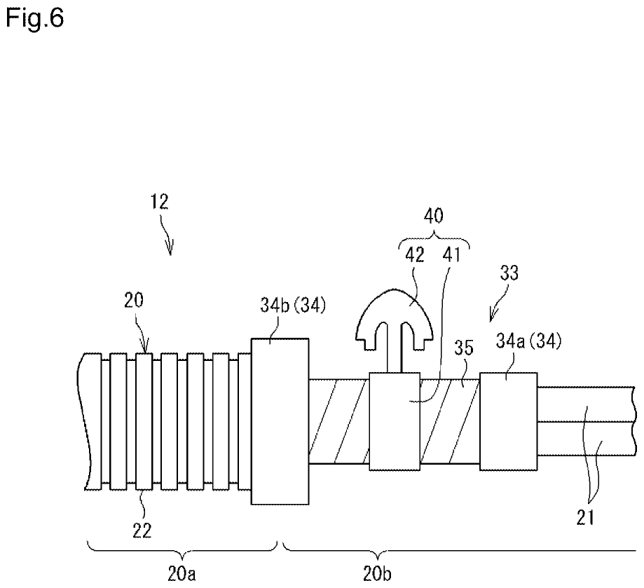

FIG. 6 is a side view of a wire harness 12 according to a third embodiment.

In the first and second embodiments, the tape members 31 and 32 are wrapped around the outer circumferential surface of the exterior member 22. However, if it is not possible to secure a sufficiently sized installation place for the wire harness inside a casing for a device or the like, there are cases where the wire harness is installed in a state where a portion of the exterior member 22 is removed to expose the electric wires 21.

In this case, in order to protect the electric wires 21 in place of the exterior member 22, it is conceivable to cover the electric wires 21 with a thick tape member. In the third embodiment, a wire harness 12 employing a thicker tape member than the tape members 31 and 32 will be described. Portions in the third embodiment likewise to the first embodiment are given like reference symbols, and detailed description thereof is omitted.

The wire harness 12 includes an electric wire member 20, a tape member 33, and a clamp 40. The tape member 33 includes first tape members 34 and a second tape member 35. The first tape members 34 are made of the same material and has the same dimensions as the tape member 31 of the first embodiment and has a thickness of 0.2 mm, for example. The second tape member 35 is thicker than the first tape members 34, and is 0.7 mm thick, for example.

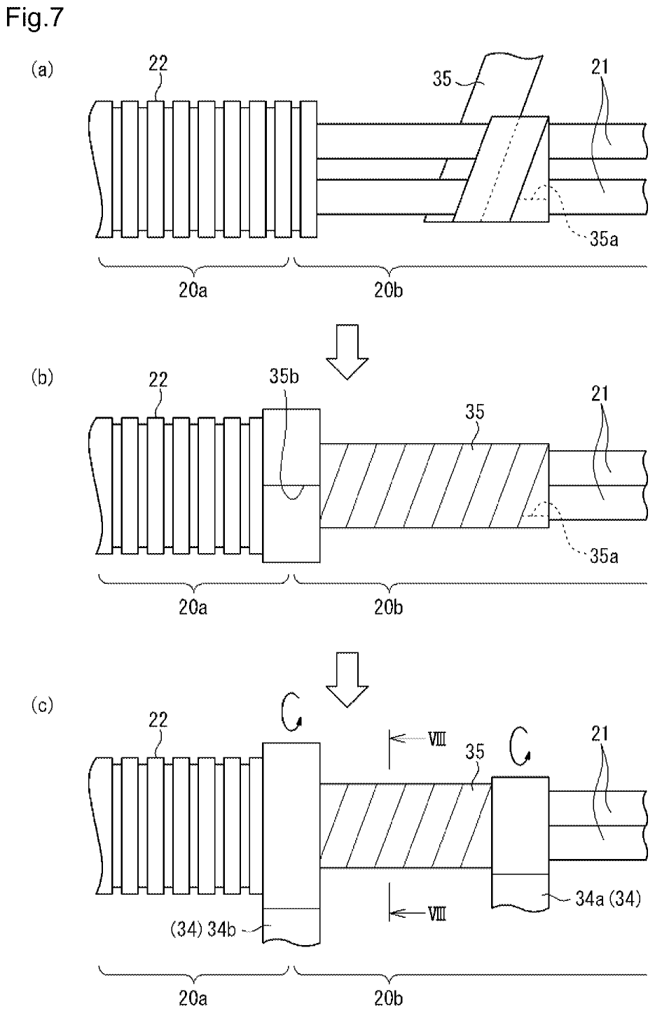

FIG. 7 is a diagram for describing a method for wrapping the tape member 33. As shown in (a) in FIG. 7, the electric wire member 20 has a first region 20a where the electric wires 21 are covered by the exterior member 22, and a second region 20b where the electric wires 21 are not covered by the exterior member 22. In the second region 20b, the electric wires 21 are directly exposed, and thus, in order to protect the electric wires 21, the thick second tape member 35 is wrapped around the outer circumferential surface of the electric wires 21 (that is, the second region 20b).

As shown in (b) in FIG. 7, the second tape member 35 is first pitch-wrapped two times, and then lap-wrapped a plurality of times (three or more times, for example), and lastly pitch-wrapped two times or more. The second tape member 35 is wrapped starting from an end portion 35a in the circumferential direction and wrapping thereof is ended at an end portion 35b.

The end portion 35b is located at position extending across the first region 20a and the second region 20b. In other words, wrapping of the second tape member 35 ends at a portion where it extends across the electric wires 21 and the exterior member 22. Accordingly, the portion of the electric wires 21 not covered by the exterior member 22 can be protected by the second tape member 35, and it is possible to prevent foreign matter from entering the exterior member 22.

The second tape member 35 is a thick piece of tape and can thus protect the electric wires 21, but because the tape is highly rigid, the end portions 35a and 35b can easily separate from the electric wires 21. Also, the end portion 35b is located at a position extending across both the first region 20a and the second region 20b, and thus can more easily separate from the electric wire member 20. Thus, in the present embodiment, as shown in (c) in FIG. 7, the thinner first tape members 34 are wrapped around the end portions 35a and 35b of the second tape member 35, thus making it possible to suppress separation of the second tape member 35 from the electric wire member 20.

The first tape members 34 are wrapped at two places, namely the wrapping-start end portion 35a and the wrapping-end end portion 35b of the second tape member 35. Hereinafter, the first tape member 34 on the end portion 35a side is referred to as a “first tape member 34a”, and the first tape member 34 on the end portion 35b side is referred to as a “first tape member 34b”, where appropriate. The first tape member 34a is pitch-wrapped a plurality of times (two times, for example) around the outer circumferential surface of the second tape member 35 including the end portion 35a. The first tape member 34b is pitch-wrapped a plurality of times (two times, for example) around the outer circumferential surface of the second tape member 35 including the end portion 35b.

The first tape member 34b is wrapped at a position extending across the first region 20a and the second region 20b. That is, the first tape member 34b covers the end portion 35b, which can easily separate, and thus it is possible to suppress separation of the second tape member 35 from the electric wire member 20.

As shown in FIG. 6, the belt 41 is attached to the outer circumferential surface of the second tape member 35. When the belt 41 is fastened to the outer circumferential surface of the thick second tape member 35, the belt 41 bites into the outer circumferential surface, and thus it is possible to suppress movement of the belt 41 in the longitudinal direction relative to the outer circumferential surface of the second tape member 35.

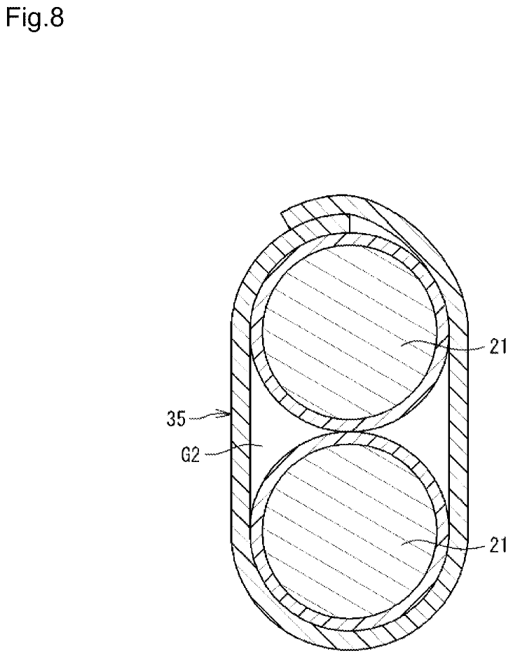

FIG. 8 is a cross-sectional view taken along a cutting line VIII in FIG. 7. In the second region 20b, the second tape member 35 bundles a plurality of electric wires 21 (two in the present embodiment) adjacent in the radial direction. At this time, a gap G2 is formed at portions where the second tape member 35 extends between the electric wires 21. Thus, even if the belt 41 is caused to bite into the outer circumferential surface of the second tape member 35 and the belt 41 is suppressed from moving in the longitudinal direction relative to the outer circumferential surface of the second tape member 35, the adhesive force between the second tape member 35 and the electric wires 21 may be overpowered by the force with which the clamp 40 is pulled on, and the clamp 40 may move together with the second tape member 35 in the longitudinal direction.

Thus, the second tape member 35 is wrapped over a longer distance in the longitudinal direction similarly to the tape member 32 of the second embodiment. Accordingly, the area of contact between the second tape member 35 and the electric wire member 20 can be increased, and it is possible to suppress sliding of the clamp 40 together with the second tape member 35 along the outer circumferential surface of the electric wire member 20.

Furthermore, as a result of wrapping the first tape members 34 around the end portions 35a and 35b, the second tape member 35 is more strongly fastened to the electric wire member 20. Accordingly, friction force between the electric wire member 20 and the second tape member 35 is increased, and it is thus possible to suppress sliding of the clamp 40 together with the second tape member 35 in the longitudinal direction along the outer circumferential surface of the electric wire member 20.

Also, the above countermeasure is realized by wrapping the first tape members 34 and the second tape member 35, and thus it is easier to suppress lateral shifting of the clamp 40, in comparison to a conventional technology employing a laser apparatus.

Note that, in the third embodiment, if prevention of separation of the end portions 35a and 35b of the second tape member 35 is not required, the first tape members 34 may be omitted.

Note that the above embodiments may at least be partially combined as necessary. The embodiments disclosed herein are exemplary in all respects, and should be construed as not being restrictive. The scope of the present disclosure is indicated by the claims rather than the above description, and all changes that come within the meaning and range of equivalency of the claims are intended to be embraced therein.

### DESCRIPTION OF THE REFERENCE CHARACTERS

10 Wire harness
11 Wire harness
12 Wire harness
20 Electric wire member
20a First region
20b Second region
21 Electric wire
22 Exterior member
22a Annular protrusion
22b Annular recess
31 Tape member
32 Tape member
32a End
32b End
33 Tape member
34 First tape member
34a First tape member
34b First tape member
35 Second tape member
35a End portion
35b End portion
40 Clamp
41 Belt
41a Lock member
41b Other end portion
42 Engaging portion
90 Attachment target
90a Hole
L1 Length (in longitudinal direction of tape member 31)
L2 Width (of belt 41)
L3 Length (in longitudinal direction of tape member 32)
W1 Width (of tape member 32)
G1 Gap
G2 Gap

1. A wire harness that is attachable to an attachment target, comprising:
an electric wire member;
a tape member wrapped around an outer circumferential surface of the electric wire member; and
a clamp including a belt attached to an outer circumferential surface of the tape member, and an engaging portion that protrudes outward in a radial direction from the belt and is engageable with the attachment target.

2. The wire harness according to claim 1,
wherein the tape member includes a portion where the tape member is wrapped a plurality of times such that overlapping occurs over a predetermined length of the tape member that is shorter than a width of the tape member in a width direction, and
the length from one end in the width direction of the wrapped tape member to another end in the width direction is greater than or equal to two times the width of the tape member.

3. The wire harness according to claim 2,
wherein the predetermined length is half the width of the tape member.

4. The wire harness according to claim 2,
wherein a gap is formed between a portion of the outer circumferential surface of the electric wire member and a portion of the tape member.

5. The wire harness according to claim 4,
wherein the electric wire member has an electric wire and an exterior member covering the electric wire,
the exterior member has annular protrusions and annular recesses alternately provided along a longitudinal direction,
the tape member is wrapped around an outer circumferential surface of the exterior member, and
the gap is formed between the tape member and the annular recesses.

6. The wire harness according to claim 4,
wherein the electric wire member includes a plurality of electric wires adjacent in the radial direction, and
the gap is formed in a portion where the tape member extends between the plurality of electric wires.

7. The wire harness according to claim 1,
wherein the tape member includes a first tape member and a second tape member thicker than the first tape member, and
the belt is attached to an outer circumferential surface of the second tape member.

8. The wire harness according to claim 7,
wherein the first tape member is wrapped around a portion of the outer circumferential surface of the second tape member that includes an end portion of the second tape member.

9. The wire harness according to claim 8,
wherein the electric wire member has a first region where an electric wire is covered by an exterior member and a second region where the electric wire is not covered by the exterior member, and
the belt is attached to a portion of the outer circumferential surface of the second tape member that is wrapped around the second region.

10. The wire harness according to claim 9,
wherein the first tape member is wrapped so as to extend across the first region and the second region.
